(19) United States
(12) Patent Application Publication
(10) Pub. No.: US 2014/0201104 A1
(43) Pub. Date: Jul. 17, 2014

(54) SYSTEM AND METHOD FOR FACILITATING COLLABORATIVE INVESTMENT BANKING AGREEMENTS

(71) Applicant: LM2 NETWORK, LLC, IRVINE, CA (US)

(72) Inventor: JAMES R. SIMPSON, IRVINE, CA (US)

(73) Assignee: LM2 NETWORK, LLC, IRVINE, CA (US)

(21) Appl. No.: 14/153,953

(22) Filed: Jan. 13, 2014

Related U.S. Application Data
(60) Provisional application No. 61/752,422, filed on Jan. 14, 2013.

(51) Int. Cl. G06Q 40/06

(52) U.S. Cl. CPC G06Q 40/06
USPC 705/36 R

(57) ABSTRACT

A system and method for facilitating collaborative investment banking agreements is disclosed. In at least one embodiment, a central computing system contains details related to an at least one lead banker, an at least one investment opportunity, and an at least one outside banker with whom the lead banker is desirous of potentially collaborating on the investment opportunity. Each banker is required to separately execute a master subscription agreement setting forth various general terms. The lead banker is then able to create the investment opportunity and present it the outside banker for a potential collaborative investment deal. The lead banker and outside banker are able to negotiate any ancillary terms specific to the investment deal which are not included in the master subscription agreement. Once agreed upon, the parties are legally bound through a third party beneficiary agreement to work the investment deal together and share in the compensation.

### RELATED APPLICATIONS

This application claims priority and is entitled to the filing date of U.S. Provisional application Ser. No. 61/752,422, filed on Jan. 14, 2013 and entitled “System and Method to Facilitate Deal Collaboration Agreements Among Investment Bankers.” The contents of the aforementioned application are incorporated by reference herein.

### INCORPORATION BY REFERENCE

Applicant hereby incorporates herein by reference any and all patents and published patent applications cited or referred to in this application.

### BACKGROUND OF THE INVENTION

1. Field of the Invention

Aspects of this invention relate generally to investment banking, and more particularly to a system and method for facilitating collaborative investment banking agreements.

2. Description of Related Art

By way of some background information, investment bankers have long been an important piece of the financial system puzzle. An investment banker is a financial professional that assists individuals, partnerships, corporations, governments, and the like in raising capital. The capital raised is used for selling or buying a variety of assets and businesses through the issuance of securities. An investment banker is typically a member of an investment bank, which may also provide ancillary services such as market making, trading of derivatives, fixed income instruments, foreign exchange, commodities, and equity securities. An investment banker who provides investment banking services in the United States is licensed and is subject to Securities & Exchange Commission (SEC) and Financial Industry Regulatory Authority (FINRA) regulation. Investment bankers use a broker-dealer, which is an entity regulated by the SEC and registered with FINRA, to address, among other things, compliance oversight and to hold their license.

When a group of investment bankers work together, they create an investment bank. Like other entities, investment banks come in different sizes. Larger investment banks are generally divided into industry coverage and product coverage groups. Industry coverage groups focus on a specific industry such as healthcare, FIG (financial institutions group), industrials, TMT (technology, media, and telecommunication). They also maintain relationships with corporations within the industry to bring in business for the investment bank. Product coverage groups focus on financial products such as mergers and acquisitions, leveraged finance, public finance, private finance (venture, lower middle market, middle market) asset finance and leasing, structured finance, restructuring and bankruptcy, equity and high-grade debt. They generally work and collaborate with industry groups on the more intricate and specialized needs of a client. Smaller investment banks may specialize in any one or multiple segments of the above categories.

The traditional investment banking process commonly begins with comprehensive analysis and planning around a securities offering. Typically, the process includes several steps. The first step is to formulate defensible growth and operating assumptions. This is accomplished by preparing comprehensive multi-year financial projections including sales and marketing, human resources, research and development and capital expenditures plans. The next step involves developing multiple valuations based on a variety of theories such as an income approach, a comparable approach and an asset approach. The third step is typically to examine internal rates of returns on the many different types of securities that can be used to appropriately capitalize the company. That is followed by determining the quantity, type and price of the securities to be sold to investors, and finally creating an ultimate “Marketable Deal Structure” (hereinafter referred to as a “deal”) that can be used to develop a successful securities offering.

Once the Investment banker has created a deal for a given securities offering, the banker will prepare, with significant client involvement, a confidential investor presentation (“CIP”) for prospective investors. A CIP is sometimes referred to as the “book” in the industry. The CIP typically contains: a detailed analysis of the marketplace including competitive overview, positioning and pricing; an overview of the client's sustainable competitive advantages and strategic growth initiatives; an overview of the client's challenges and areas for strengthening; an overview of key management and experience; a presentation and analysis of historical and projected client financials; a discussion of the client's capital structure; and a discussion of proposed financing. Penultimately, corporate counsel will develop a confidentiality agreement to be used with prospective investors. Lastly, the investment banker will prepare a list of potential investors, buyers, and sellers (hereinafter referred to as “prospects”). The investment banker will collect target prospects from a variety of sources, including but not limited to: internal databases; external information service providers such as CapIQ, Pitchbook, and BigDough; market research; and their investment bankers and industry participants. For many segments of the investment banking market, the universe of prospects is highly fragmented and constantly evolving. There are approximately 10,000 institutional investment capital groups (venture, private equity and hedge funds), over 300,000 medium and large-sized, private and public companies and tens of thousands of high net individuals, investment clubs, family offices and equity sponsors in the United States alone. The investment bankers' challenge is to identify from this large universe prospects that are most appropriate for the investment opportunity and the client's objectives. Target prospects typically possess a unique combination of financial capability, synergistic value with the client's business, time-table alignment and willingness to largely meet or exceed the client's market-based valuation expectations in respect to both price and terms. The ability of the investment bankers to identify highly qualified prospects significantly improves the executability and the velocity of a successful transaction. The executability of a transaction refers the investment banker's ability to achieve the client's objectives, which largely depends on the investment banker's ability to identify and properly approach highly qualified prospects. The velocity of a transaction encapsulates the need to maintain adequate momentum in a transaction such that the client remains committed to the process. The ability of the investment banker to quickly identify highly qualified prospects for the transaction significantly improves the chances of a successful closing of a transaction.

The next stage of the transaction typically involves the marketing of the investment opportunity, through which the investment banker will develop and send to prospects an executive summary (referred to in the industry as the “teaser”) of the investment opportunity. The executive summary typically contains no confidential information about the company. A purpose of the executive summary is to elicit preliminary interest from the prospects and, when properly qualified, to lead to the sending of the CIP after the execution of the confidentiality agreement. Following the delivery of the CIP, the investment bankers will further qualify prospects to cull the list to a limited number of client management presentations.

The next stage of the transaction typically involves conducting management presentations, through which the investment banker will schedule a limited number of management presentations to highly qualified prospects. The investment banker will draft the management presentation, will coach management through practice meetings and will anticipate questions and issues. Following the management presentations, the investment bankers will confirm interest and a broad range of pricing from the remaining prospects.

The next stage of the transaction typically involves the investment bankers issuing preliminary diligence data about the client to the remaining prospects and addressing prospect questions not adequately covered in the CIP and management presentation. Typically, the prospects will have follow-on conference calls with client management. At the end of this stage, the investment banker will request non-binding letters of intent (“LOI”) from prospects outlining major terms of the proposed transaction. The investment banker and client will thereafter strategize as to the best approach to negotiate the terms and typically settle on an acceptable basis to select one prospect to execute the LOI.

In the last stage of the transaction, the investment bankers will typically manage responses to detailed buyer diligence requests, will lead or assist in the negotiating of definitive documentation, will negotiate remaining unresolved issues between the client and prospect(s) and, to the extent necessary, will identify and arrange, typically with the assistance of the prospect, other required financing aspects of the transaction such as working capital line, equipment leasing, mezzanine debt, etc.

As discussed above, investment bankers prepare a list of potential prospects as is appropriate for the particular client engagement. The investment banker will collect target prospects from a variety of sources, including but not limited to: internal databases; external information service providers; market research; and their investment bankers and industry participants. No one source is comprehensive or adequate as the universe of prospects is large, highly fragmented and constantly evolving. Yet, the transaction's executability and velocity largely depend upon timely identifying and properly approaching highly qualified prospects.

Thus, there is a need in the art for a system and method for improving the executability and velocity determinants of a successful closing of a transaction as well as a novel approach to significantly improving the investment bankers' ability to meet the various required financing conditions precedent to closing of a transaction. Aspects of the present invention fulfill these needs and provide further related advantages as described in the following summary.

### SUMMARY OF THE INVENTION

Aspects of the present invention teach certain benefits in construction and use which give rise to the exemplary advantages described below.

The present invention solves the problems described above by providing a system and method for facilitating collaborative investment banking agreements. In at least one embodiment, a central computing system is configured for receiving and processing data related to an at least one investment opportunity, an at least one lead banker, an at least one outside banker, an at least one investment deal related to the investment opportunity as between the at least one lead banker and the at least one outside banker, and an at least one prospect. Using a computing device in communication with the computing system, each of the lead banker and outside banker separately execute a master subscription agreement setting forth pricing and terms of service along with respective rights and obligations. The lead banker is then able to create the at least one investment opportunity and subsequently present it the outside banker and negotiate an investment deal related thereto. For any outside bankers that are interested in participating in the investment deal, subject to approval by the lead banker, the lead banker and outside banker are able to negotiate any ancillary terms specific to the investment deal which are not included in the master subscription agreement. Once agreed upon, the agreements generated by the computing system legally bind each party through a third party beneficiary agreement to work the investment deal together and share in the compensation.

A primary objective inherent in the above described system and methods of use is to provide advantages not taught by the prior art.

Another objective is to provide such a system and associated methods that are capable of providing investment bankers the ability to electronically share certain elements of an investment opportunity with others investment bankers and thereafter to electronically create a binding agreement with any number of said other investment bankers as to material terms including sharing ratios of compensation derived from the subject investment opportunity, in at least one embodiment.

A still further objective is to provide such a system and associated methods that are capable of enabling investment bankers to improve the executability and velocity of investment opportunities, in at least one embodiment.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary system for facilitating investment banking agreements, in accordance with at least one embodiment;

FIG. 2 is a flow diagram of an exemplary method for facilitating investment banking agreements, in accordance with at least one embodiment;

FIG. 3 is a flow diagram of an exemplary method for presenting and negotiating an investment deal with an at least one outside banker, in accordance with at least one embodiment;

FIG. 4 is an exemplary illustration of an Internet browser or similar application window depicting an exemplary investment deal presented to the at least one outside banker, as displayed by an exemplary computing device, in accordance with at least one embodiment;

FIG. 5 is an exemplary illustration of an Internet browser or similar application window depicting an exemplary user interface, as displayed by an exemplary computing device, in accordance with at least one embodiment; and

FIG. 6 is an exemplary illustration of an Internet browser or similar application window depicting a further exemplary user interface, as displayed by an exemplary computing device, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

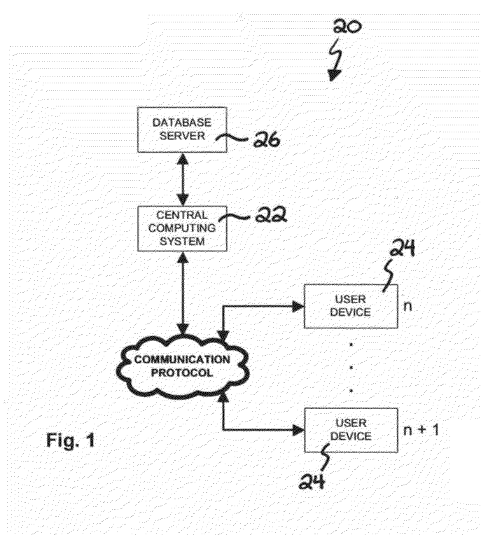

Turning now to FIG. 1, there is shown a simplified schematic view of an exemplary investment banking system 20 for facilitating deal collaboration agreements among investment bankers, in accordance with at least one embodiment. The system 20 provides, in at least one embodiment, a central computing system 22 configured for receiving and processing data related to each of an at least one investment opportunity, an at least one lead banker (i.e., an investment banker desirous of sharing information about his or her investment opportunity with other investment bankers), an at least one outside banker (i.e., an investment banker who is a member of the system 20 and with whom the at least one lead banker might share information about said investment opportunity), an at least one investment deal related to the investment opportunity as between the at least one lead banker and the at least one outside banker, and an at least one prospect, as discussed further below. The system 20 further provides, in at least one embodiment, an at least one user device 24 in selective communication with the computing system 22. Additionally, in at least one embodiment, a database server 26 is in communication with the computing system 22 and configured for selectively storing said data related to the at least one investment opportunity, lead banker, outside banker, investment deal, and prospect.

At the outset, it should be noted that the means for allowing communication between each of the computing system 22, at least one user device 24, and database server in 26 may be any wired- or wireless-based communication protocol (or combination of protocols) now known or later developed. As such, the present invention should not be read as being limited to any one particular type of communication protocol, even though certain exemplary protocols may be mentioned herein for illustrative purposes. It should also be noted that the term “user device” is intended to include any type of computing device now known or later developed, such as desktop computers, mobile phones, smartphones, laptop computers, tablet computers, personal data assistants, gaming devices, etc.

With continued reference to FIG. 1, in the exemplary embodiment, the computing system 22 contains the hardware and software necessary to carry out the exemplary methods for facilitating investment banking agreements as described herein. Furthermore, in at least one embodiment, the computing system 22 comprises a plurality of computing devices selectively working in concert with one another to carry out the exemplary methods for facilitating investment banking agreements as described herein. In at least one alternate embodiment, the computing system 22 and database server 26 are one and the same. The at least one user device 24 is in the possession of one of the at least one investment bankers (i.e., lead bankers and outside bankers).

Generally speaking, and as described in detail below, the computing system 22 maintains a network of investment bankers and provides a website portal through which the investment bankers may utilize the various functions capable of being carried out by the computing system 22, as described in detail below.

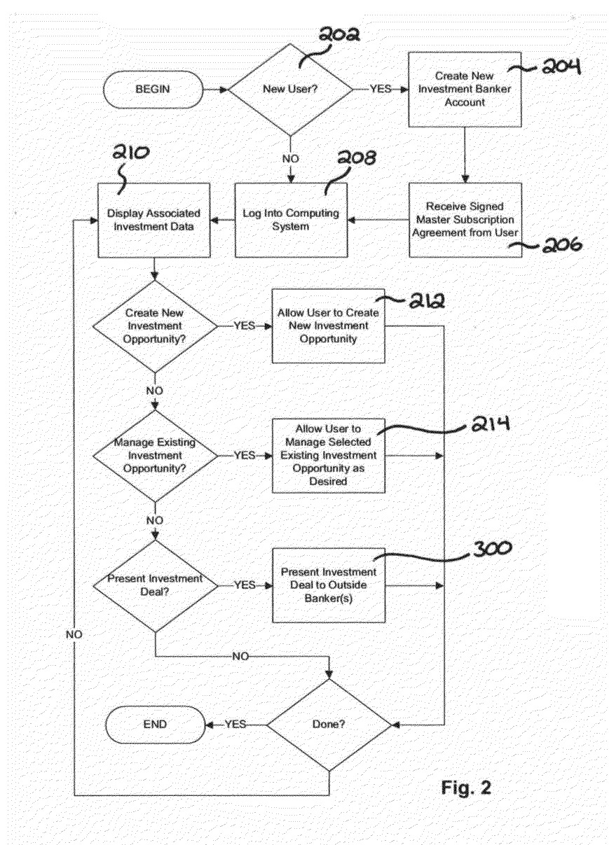

In use, in at least one embodiment as illustrated in the flow diagram of FIG. 2, if the investment banker is a new user/member of the system 20 (202), they must first properly register with the computing system 22 by creating an account via the user device 24 (204). In at least one embodiment, membership in the network is granted to select investment bankers who submit an application and pay a required fee for their membership. Applications for membership are reviewed by a membership committee, which sets the in criteria for acceptance of new members into the network. Once approved, each investment banker signs a master subscription agreement (206) which sets forth pricing and terms of service, rights and obligations of the investment bankers and the system 20, and binds the investment bankers to conduct themselves in a prescribed manner, e.g., to keep certain information confidential.

Known prior art methods are inefficient, in part, because investment bankers must first execute a confidentiality agreement with the other investment bankers to protect and treat as confidential the information about the investment opportunity desired to be shared and presented to the other investment bankers. To solve this inefficiency, in at least one embodiment, the master subscription agreement includes language that creates a third party beneficiary agreement between each investment banker who is a member of the system 20 to meet the confidentiality requirements regarding sharing information about an investment opportunity with other investment banker members. In doing so, the master subscription agreement enables lead bankers to share information about their investment opportunities without first having to execute a separate confidentiality agreement with outside bankers.

Known prior art methods are also inefficient, in part, because after investment bankers have orally agreed to work on an investment opportunity with other investment bankers, the parties must then draft and execute a contract governing the terms of their engagement. To solve this inefficiency, in at least one embodiment, the master subscription agreement also includes language that creates a third party beneficiary agreement between each investment banker member which establishes an agreed upon Internet-based electronic method to capture the terms of engagement between the lead bankers and outside bankers related to a particular investment opportunity. In doing so, the master subscription agreement enables the lead bankers to efficiently collaborate with outside bankers about an investment opportunity without having to first draft and execute a separate contract.

In at least one embodiment, the master subscription agreement also includes language that creates a legally binding third-party beneficiary agreement between two or in more investment bankers if and when they should complete certain specified steps built into the system 20.

With continued reference to FIG. 2, once a given investment banker has signed the master subscription agreement and created an account with the computing system 22, the investment banker is able to log into the computing system 22 (208)—again, via the user device 24—at which point the computing system 22 allows the investment banker access to any investment opportunities, lead bankers, outside bankers, investment deals, and prospects that are associated with the investment banker, as discussed further below. In the exemplary embodiment, the associated investment opportunities, lead bankers, outside bankers, investment deals, and prospects are appropriately displayed via an at least one user interface 28 provided by a website portal that is hosted by the computing system 22 and/or database server 26 (210). From the user interface 28, the investment banker is able to selectively create new investment opportunities (212), manage existing investment opportunities created by the investment banker (214), and present and negotiate investment deals with one or more outside bankers (300) among other tasks, in at least one embodiment.

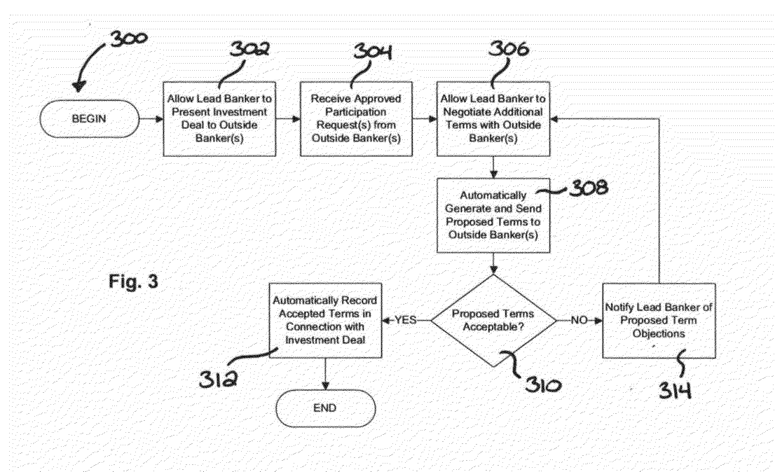

In at least one embodiment, investment bankers who are members of the system 20 have the ability to selectively present, as lead bankers, investment opportunities to outside bankers in order to create collaboration opportunities (i.e., investment deals) and generate interest in said investment deals. As illustrated in the flow diagram of FIG. 3, during these deal presentation sessions, lead bankers present the investment deal, which contains information related to a particular investment opportunity, to outside bankers (302). Outside Bankers who are interested may propose to participate in a given investment deal subject to the lead banker's approval (304). Ancillary provisions which are not included in the master subscription agreement, such as the sharing ratios, may be negotiated between the lead banker and prospective outside banker (306). Once the lead banker completes specified steps via the computing system 22, an email is automatically sent to the outside banker specifying the proposed terms (308). If the terms are acceptable (310), the outside banker will click on a button contained in the email which will cause the computing system 22 to automatically record the email in the activity history associated with the investment deal as stored in the computing system 22 or database server 26 (312). If the terms are unacceptable, the computing system 22 will create and send an email to the lead banker where the outside banker may specify the problems with the terms (314). An approved email evidencing agreement of investment deal-specific terms between the lead banker and outside banker in conjunction with the master subscription agreement provisions guarantee an enforceable agreement between the lead banker, lead banker's firm, outside banker and outside banker's firm and allow the investment deal to occur. The master subscription agreement includes provisions that allow two or more investment bankers to work jointly on a given investment deal. Once the investment deal-specific provisions are agreed to and sent to the computing system 22, the master subscription agreement legally binds the interested investment bankers through a third party beneficiary agreement. Thus, what used to take days, if not weeks to complete—namely, a binding agreement between two or more investment bankers to work an investment deal together and share in the compensation—is now done literally instantaneously.

Known prior art methods are inefficient and limited, in part, because investment bankers must identify and contact appropriate other investment bankers about an investment opportunity and, following the execution of an appropriate confidentiality agreement, must present pertinent information about the investment opportunity in a format easily understandable to the other investment bankers or risk losing the potential interest of the other investment bankers. There is no industry standard as to investment opportunity presentment format which creates a chilling effect on industry use of such known prior art methods. To solve these inefficiencies, in at least one embodiment, the system 20 incorporates several novel elements to substantially improve the efficiency of the identification and contacting of outside bankers and the presentment of investment deals.

One such novel element is the use of a network deal review mechanism. In at least one embodiment, the network deal review is a periodic one-hour private Internet-based meeting made available by the computing system 22 to investment banker members and other invited participants accessible through a computing device—though, in further embodiments, the length and frequency of such deal review mechanism sessions could vary. Outside bankers may be invited to attend network deal review sessions where lead bankers present investment deals to outside bankers and other invited participants. Each network deal review may attract multitudes of outside bankers and other invited participants. In each network deal review, outside bankers may be presented with up to twenty separate investment opportunities. Outside bankers attend network deal review sessions because they are efficiently presented with multiple investment opportunities on which they may potentially collaborate subject to agreement with the lead banker. lead bankers present investment deals via network deal review sessions because it may substantially improve the underlying investment opportunity's executability and velocity. By collecting tens to hundreds of invited attendees in each network deal review session, the system 20 substantially improves the lead banker's ability to efficiently identify and contact appropriate outside bankers about an investment opportunity.

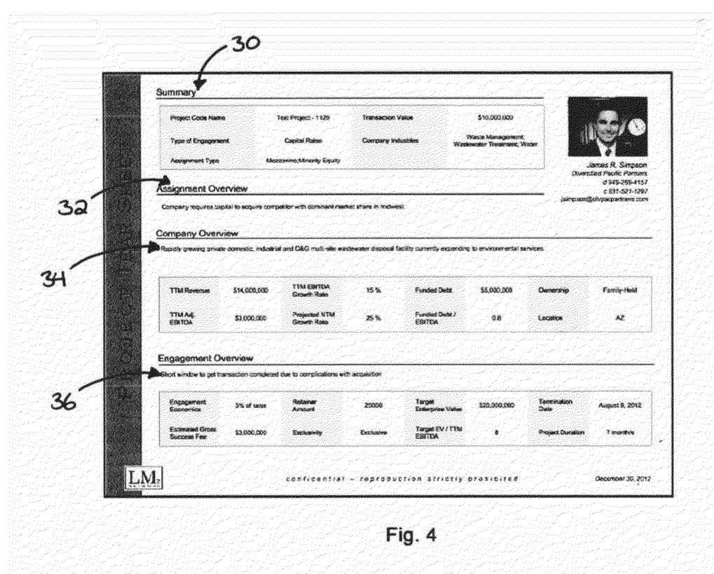

The computing system 22 also creates standardized information presentment formats such that attendees of network deal review sessions may efficiently review the investment deal and underlying investment opportunity. With reference to FIG. 4, which shows an exemplary investment deal to be presented to the at least one outside banker, in accordance with at least one embodiment, as displayed via an Internet browser or similar application window on the screen of the user device 24, an exemplary presentment format includes a summary section 30, an assignment overview section 32, a company overview 34 section and an engagement overview section 36 providing attendees of network deal review sessions information critical to their evaluation of the proposed investment deal. Because each investment deal and underlying investment opportunity is presented consistently in the presentment format, in at least one embodiment, attendees are able to quickly and efficiently identify aspects of the investment opportunity important to their evaluation. Again, the efficiency of the information exchange allows for up to twenty investment opportunities to be properly presented in a one-hour period. The amount of investment opportunities presented in a network deal review session directly correlates to the perceived value of the network deal review mechanism and is critical to increasing the participation rate of investment bankers in the system 20.

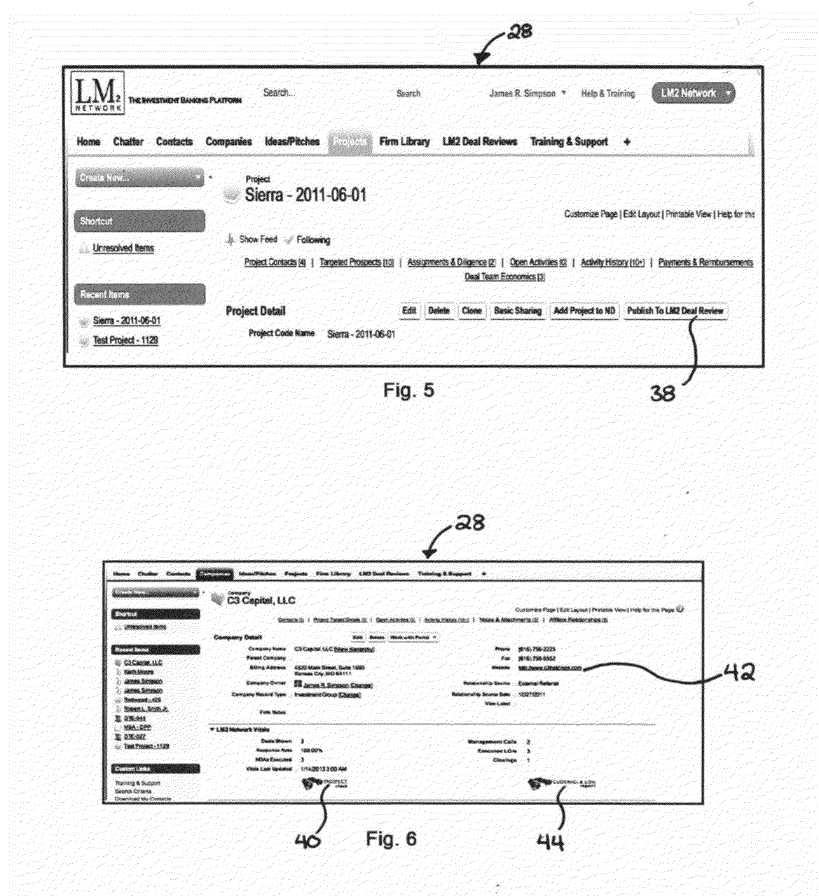

The computing system 22 also creates an automated method for a lead banker to electronically complete the presentation format with the desired information about an investment opportunity and thereafter to electronically add the investment opportunity to the next applicable network deal review session. With reference to FIG. 5, which shows an exemplary user interface 28, in accordance with at least one embodiment, as displayed via an Internet browser or similar application window on the screen of the user device 24, the computing system 22 provides a publish button 38 associated with the lead banker's investment opportunity. Upon the lead banker clicking the publish button 38, the computing system 22 automatically collects information about the investment opportunity from various sources within the computing system 22 and/or database server 26 needed to complete the presentation format and then places the information into a computer readable file, such as a portable document format (i.e., .pdf), in a way consistent with the illustration set forth in FIG. 4, in at least one embodiment. The computing system 22 then allows the lead banker to confidentially preview the investment opportunity presentation format to ensure that no undesired information is contained prior to electronically submitting it to the next applicable network deal review session. For example, the lead banker may want to withhold certain types of information about the investment opportunity until later in the investment deal process. Thus, the above described methods of the present system 20 significantly improve the efficiency and consistency of the information presentment step of the investment deal process.

In at least one embodiment, following receipt of information about an investment opportunity, the computing system 22 allows the lead banker to independently check whether target prospects the outside bankers may want to propose to the lead banker are prospects the lead banker has already targeted for the investment opportunity. Such a mechanism significantly enhances the investment deal process because it provides lead bankers with greater confidence in the integrity of the system 20 and hence improves to participation in the investment deal process. This method of checking prospects is achieved, in at least one embodiment, through the interaction of three mechanisms which are detailed below.

First, the computing system 22 allows the lead banker of a given investment opportunity, along with any outside bankers permitted by the lead banker, to associate target prospects with the lead banker's investment opportunity. Following industry best practices, the lead banker will first source prospects for the investment opportunity utilizing internal databases, external information service providers and market research, and, when appropriate, associate said prospects with the investment opportunity, prior to sourcing and adding prospects through their investment bankers and industry participants.

Second, the computing system 22 allows outside bankers to complete a prospect check by clicking a prospect button 40 provided by the computing system 22 via the user interface 28 and associated with a given prospect, as illustrated in FIG. 6. Upon the prospect button 40 being clicked, the computing system 22 requires the outside banker to choose the appropriate investment opportunity being presented by the lead banker. The computing system 22 then determines whether the given prospect is currently associated with the investment opportunity as a target prospect and notifies the outside banker accordingly.

Third, to account for potentially different naming conventions of the same prospect by different investment bankers, the computing system 22 identifies and maintains each prospect by a unique website URL 42 associated with the prospect. Unlike the various potential naming conventions for a prospect's account name, the prospect's URL 42 must be identical for all investment bankers because an given prospect's website may only have one URL.

In at least one embodiment, the computing system 22 also allows the lead banker of a given investment opportunity to search the computing system 22 and/or database server 26 for outside bankers possessing direct experience with a given prospect sourced by the lead banker for the investment opportunity, referred to as an experience check. The experience check substantially improves the lead banker's ability to properly approach specific prospects with which the lead banker does not currently have a substantive relationship. It has been found that certain prospects respond more quickly and/or substantively if the investment opportunity is introduced to it by a banker with which it has an existing substantive relationship. In a bit more detail, with continued reference to FIG. 6, the computing system 22 provides a closing button 44 on the user interface 28 that, when clicked, causes the computing system 22 to search the computing system 22 and/or database server 26 for outside bankers who have either completed a letter of intent or closing with the given prospect. If desired, the lead banker may thereafter contact one or more of the discovered outside bankers to evaluate the merit of collaborating with one or more of them to approach the given prospect. Thus, the above described method of the present system 20 substantially improves the lead banker's ability to properly approach prospects.

Known prior art methods are also inefficient, in part, because they require the drafting and execution of an engagement contract between investment bankers following the identification, contacting and presentment steps. Furthermore, once such an engagement agreement has been executed between investment bankers, known prior art methods lack the ability for the parties to monitor compliance with the agreement. To solve these inefficiencies, in at least one embodiment, the computing system 22 enables the lead banker to efficiently create a binding third party beneficiary agreement electronically with any number of outside bankers as to material terms, including sharing of compensation derived from the subject investment opportunity. Additionally, the computing system 22 provides electronic mechanisms to help ensure compliance with the engagement agreement, as discussed further below.

In at least one embodiment, the computing system 22 allows the lead banker to capture the agreed upon engagement terms with the at least one outside banker through the completion of a plurality of steps built into the system 20. Procedurally, following an oral agreement between the lead banker and outside banker related to an investment opportunity, the lead banker captures, via the computing system 22, the terms of the oral agreement, including but not necessarily limited to the economic split of retainer, economic split of commission, compensation on all prospects or identified prospects and, if identified prospects, the naming of said identified prospects and whether the outside banker is a selling group participant. Upon entering the terms of the oral agreement into the computing system 22, the computing system 22 automatically generates an email to the outside banker through which the outside banker may review the terms and the applicable master subscription agreement, and electronically accept the terms or reject the terms for specified reasons. If and when accepted, the binding third party beneficiary agreement is established between the lead banker and outside banker and their respective firms, incorporating the agreed upon terms as well as the pertinent legal language contained in the master subscription agreement. These terms may be changed at any time, upon election of the parties, using the same process. As mentioned above, the computing system 22 automatically records the agreement, along with any amendments thereto, in the activity history associated with the investment deal as stored in the computing system 22 or database server 26. These records cannot be deleted or modified by the investment bankers, in order to ensure the integrity of the records.

Known prior art methods are also inefficient and limited, in part, because they do not incorporate methods for investment bankers to functionally collaborate after the completion of the requisite identification, contacting, presentment and contracting steps. To maximize collaborative value, investment bankers must be able to efficiently share information about their joint efforts related to the investment opportunity. To address this deficiency, in at least one embodiment, the computing system 22 provides multiple methods by which the lead banker and outside bankers may functionally collaborate with one another. In one such method, following the identification, contacting, presentment and contracting steps discussed above, outside bankers will introduce the lead banker to the appropriate contacts associated with the identified prospects, and the lead banker will thereafter manage the interaction with the identified prospects relating to the investment to opportunity. In another such method, following the identification, contacting, presentment and contracting steps discussed above, outside bankers will introduce the lead banker's investment opportunity to and thereafter manage interaction with the identified prospects. To accomplish this particular method, after the lead banker associates the desired outside banker to the investment opportunity, the computing system 22 allows the outside banker to electronically view, edit and interact with limited portions of the associated investment opportunity. This particular method does not allow the outside banker to view targeted prospects associated with the investment opportunity that were not supplied by or otherwise already associated with the outside banker. This restriction of data is critical for at least two reasons. First, lead bankers typically do not want to share such data with outside bankers. Second, the ability of lead bankers to collaborate with multiple outside bankers on an investment opportunity would be compromised if the outside bankers could view, edit and interact with data from other outside bankers. In yet another such method, following the identification, contacting, presentment and contracting steps discussed above, the lead banker may instruct the computing system 22 to share specified portions of the restricted data with the outside banker.

Thus, the system 20 provides investment bankers with the ability to electronically share certain elements of an investment opportunity with outside bankers and thereafter to electronically create a binding agreement with any number of the outside bankers as to material terms, including sharing ratios of compensation derived from the subject investment opportunity. By substantially improving the ability to efficiently identify, contact, present to, and contract with appropriate outside bankers, the system 20, in at least one embodiment, enables investment bankers to improve the executability and velocity of investment opportunities.

To summarize, regarding the exemplary embodiments of the present invention as shown and described herein, it will be appreciated that a system and method for facilitating collaborative investment banking agreements is disclosed. Because the principles of the invention may be practiced in a number of configurations beyond those shown and described, it is to be understood that the invention is not in any way limited by the exemplary embodiments, but is generally directed to a system and method for facilitating collaborative investment banking agreements and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input to device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor believes that the claimed subject matter is the invention.

What is claimed is:

1. A method for facilitating collaborative investment banking agreements between an at least one lead banker, having knowledge of an at least one investment opportunity, and an at least one outside banker with whom the at least one lead banker is desirous of potentially collaborating on said investment opportunity, the method comprising the steps of:
implementing a central computing system configured for receiving and processing data related to each of the at least one lead banker, at least one outside banker, and at least one investment opportunity;
using a computing device in communication with the computing system to create an account associated with each of the at least one lead banker and at least one outside banker;
requiring each of the at least one lead banker and at least one outside banker to execute a master subscription agreement setting forth pricing and terms of service along with respective rights and obligations;
allowing the at least one lead banker to create the at least one investment opportunity;
allowing the at least one lead banker to present the at least one investment opportunity to at least one of the outside bankers and negotiate an investment deal related thereto;
allowing the at least one outside banker to participate in said investment deal subject to approval by the lead banker;
allowing the lead banker and at least one outside banker to negotiate any ancillary terms specific to the investment deal which are not included in the master subscription agreement; and
legally binding each of the at least one lead banker and at least one outside banker through a third party beneficiary agreement to work the investment deal together and share in the compensation.

2. The method of claim 1, further comprising the step of implementing a database server in communication with the computing system and configured for selectively storing said data related to the at least one lead banker, at least one outside banker, and at least one investment opportunity.

3. The method of claim 1, further comprising the step of including in the master subscription agreement language that creates a third party beneficiary agreement between each of the at least one lead banker and at least one outside banker.

4. The method of claim 1, further comprising the step of selectively displaying data associated with each of the at least one lead banker, at least one outside banker, and at least one investment opportunity via an at least one user interface provided by a website portal hosted by the computing system.

5. The method of claim 1, further comprising the step of allowing the at least one lead banker to associate with the at least one investment opportunity an at least one prospect who might be interested in and capable of investing in the at least one investment opportunity.

6. The method of claim 5, further comprising the steps of:
allowing the at least one lead banker to determine whether any prospects the at least one outside banker may desire to propose to the lead banker are already associated with and, thus, already targeted for the at least one investment opportunity;
allowing the at least one outside banker to determine whether a given prospect is already associated with and, thus, already targeted for the at least one investment opportunity; and
automatically organizing and maintaining data related to the at least one prospect based on a unique website URL associated with each said prospect.

7. The method of claim 5, further comprising the step of allowing the at least one lead banker to determine whether any outside bankers possess direct experience with a given prospect with whom the lead banker has associated the at least one investment opportunity.

8. The method of claim 7, further comprising the step of automatically determining whether any outside bankers have either completed an letter of intent or closing with a given prospect associated with the at least one investment opportunity.

9. The method of claim 7, further comprising the step of allowing the lead banker to contact the at least one outside banker possessing direct experience with a given prospect in order to evaluate the merit of collaborating with said outside banker for approaching said prospect.

10. The method of claim 1, further comprising the step of, upon completion of the requisite identification, contacting, presentment and contracting steps, allowing the at least one lead banker and at least one outside banker associated with the at least one investment deal to selectively share information about their joint efforts related to the investment opportunity.

11. The method of claim 10, further comprising the step of allowing the at least one outside banker to introduce the at least one lead banker to the appropriate contacts associated with the at least one prospect so that the lead banker may thereafter manage the interaction with said prospect relating to the investment opportunity.

12. The method of claim 10, further comprising the step of allowing the at least one outside banker to introduce the investment opportunity to and thereafter manage interaction with select ones of the at least one prospect with whom the at least one outside banker has direct experience.

13. The method of claim 10, further comprising the step of allowing the at least one lead banker to share with the at least one outside banker portions of data associated with the at least one prospect as specified by said lead banker.

14. The method of claim 1, further comprising the step of allowing the at least one lead banker to manage the data associated with the at least one investment opportunity.

15. The method of claim 1, further comprising the step of automatically standardizing the data associated with the at least one investment opportunity for presentment purposes in a format that includes a summary section, an assignment overview section, a company overview section and an engagement overview section, thereby providing the at least one outside banker with information critical to their evaluation of the investment deal.

16. The method of claim 15, further comprising the step of allowing the at least one lead banker to confidentially review and approve the standardized data associated with the at least one investment opportunity prior to it being presented to the at least one outside banker.

17. The method of claim 1, wherein the step of allowing the lead banker and at least one outside banker to negotiate any ancillary terms further comprises the steps of:
automatically transmitting the proposed ancillary terms in writing to the at least one outside banker for written approval; and
upon written acceptance of the ancillary terms by the at least one outside banker, automatically storing the written approval in at least one of the computing system and database server.

18. A method for facilitating collaborative investment banking agreements between an at least one lead banker, having knowledge of an at least one investment opportunity, and an at least one outside banker with whom the at least one lead banker is desirous of potentially collaborating on said investment opportunity, the method comprising the steps of:
implementing a central computing system configured for receiving and processing data related to each of the at least one lead banker, at least one outside banker, and at least one investment opportunity;
using a computing device in communication with the computing system to create an account associated with each of the at least one lead banker and at least one outside banker;
requiring each of the at least one lead banker and at least one outside banker to execute a master subscription agreement setting forth pricing and terms of service along with respective rights and obligations;
allowing the at least one lead banker to create the at least one investment opportunity;
allowing the at least one lead banker to associate with the at least one investment opportunity an at least one prospect who might be interested in and capable of investing in the at least one investment opportunity;
allowing the at least one lead banker to present the at least one investment opportunity to at least one of the outside bankers and negotiate an investment deal related thereto;
allowing the at least one outside banker to participate in said investment deal subject to approval by the lead banker;
allowing the lead banker and at least one outside banker to negotiate any ancillary terms specific to the investment deal which are not included in the master subscription agreement;
legally binding each of the at least one lead banker and at least one outside banker through a third party beneficiary agreement to work the investment deal together and share in the compensation; and
upon completion of the requisite identification, contacting, presentment and contracting steps, allowing the at least one lead banker and at least one outside banker associated with the at least one investment deal to selectively share information about their joint efforts related to the investment opportunity.

19. A method for facilitating collaborative investment banking agreements between an at least one lead banker, having knowledge of an at least one investment opportunity, and an at least one outside banker with whom the at least one lead banker is desirous of potentially collaborating on said investment opportunity, the method comprising the steps of:
implementing a central computing system configured for receiving and processing data related to each of the at least one lead banker, at least one outside banker, and at least one investment opportunity;
using a computing device in communication with the computing system to create an account associated with each of the at least one lead banker and at least one outside banker;
requiring each of the at least one lead banker and at least one outside banker to execute a master subscription agreement setting forth pricing and terms of service along with respective rights and obligations;
allowing the at least one lead banker to create the at least one investment opportunity;
allowing the at least one lead banker to present the at least one investment opportunity to at least one of the outside bankers and negotiate an investment deal related thereto;
automatically standardizing the data associated with the at least one investment opportunity for presentment purposes in a format that includes a summary section, an assignment overview section, a company overview section and an engagement overview section, thereby providing the at least one outside banker with information critical to their evaluation of the investment deal;
allowing the at least one outside banker to participate in said investment deal subject to approval by the lead banker;
allowing the lead banker and at least one outside banker to negotiate any ancillary terms specific to the investment deal which are not included in the master subscription agreement; and
legally binding each of the at least one lead banker and at least one outside banker through a third party beneficiary agreement to work the investment deal together and share in the compensation.
